(19) United States
(12) Patent Application Publication
(10) Pub. No.: US 2002/0124048 A1
(43) Pub. Date: Sep. 5, 2002

(54) Web based interactive multimedia story authoring system and method

(76) Inventor: Qin Zhou, Littleton, CO (US)

Correspondence Address: ANCEL W. LEWIS, JR., 425 WEST MULBERRY, SUITE 101, FORT COLLINS, CO, 80521, US

(21) Appl. No.: 09/799,413

(22) Filed: Mar. 5, 2001

(51) Int. Cl. G06F 15/16

(52) U.S. Cl. 709/203; 709/205

(57) ABSTRACT

A web based interactive multimedia story authoring system and method are provided including a user part, a computer server part, and a means of communication part. A user accesses a web site through the means of communication, the web site being hosted by the computer server. The user is able to create stories while being logged on to the web site, through selection of various story components as arranged and selected by the user. Story components may include text, background, character/objects, music/audio, or other files stored at the computer server, as well as files which may be uploaded to the computer server by the user. The web site provides various user executable commands to add, delete, or modify components of a story. The web based authoring system allows for publication of stories to a worldwide audience, and facilitates writing competitions to anyone having access to the worldwide web. User accounts may be established for frequent users allowing a user to save and publish stories. Because the system is web based, there is virtually a limitless amount of data to choose from in terms of components to make up a particular story.

### FIELD OF THE INVENTION

The present invention relates to an interactive multimedia story authoring system and method. More specifically, the present invention relates to a web based story authoring system and method wherein stories are created through a web site on the worldwide web, and data making up story components is made available by a host computer server.

### BACKGROUND OF THE INVENTION

A communications revolution has occurred due to use of the worldwide web not only as a means of communication, but also as a means to conduct commerce for nearly every type of commercial or business activity. Along with the evolution of the worldwide web, there has also been enhancements in the way in which the worldwide web is made accessible. Today, there are multiple devices which can be used to access the worldwide web to include wireless devices, personal electronic devices often referred to as personal digital assistants (PDAs), interactive television sets, and of course, traditional personal computers.

The worldwide web has enabled educational institutions to enhance information made available to students, for example, students use the worldwide web as a new research tool. The worldwide web is used in many schools as an integral feature to many courses taught. Several CD ROM based software products have been developed to enable children to create their own stories. An example of such CD ROM based software is entitled Story Book Weaver.

Story Book Weaver is a CD-ROM based program. By creating your own books with pictures, words and sounds you can improve your writing skills and have fun in the process. Write a mystery, an adventure, a fairy tale or keep a travel journal or illustrated diary. Choose from thousands of contemporary and folklore images to illustrate your creation, modify them or create your own. You can even add sounds with an exciting text-to-speech feature that allows children to hear their stories read aloud. Story Book Weaver Deluxe is bilingual so you can write in either English or Spanish.

Although these CD ROM based software products may enable a child to author their own story based upon data which is made available on the CD ROM, CD ROM products have many disadvantages. One disadvantage of CD ROM products is that the content provided on the CD ROM is limited to the amount of data that can be stored on the CD ROM. Another disadvantage is that the CD ROM must be physically installed on a computer. In terms of sharing a story, the CD ROM format makes it difficult to transfer stories created as files to be read on other computers of other users. Organizing writing competitions with a CD ROM based product is also very difficult based upon the number of CD ROM installations required, and the effort required to actually physically transfer computer files of the stories to the party responsible for reviewing the stories. Additionally, there are compatibility issues with regard to using CD ROM products on new platforms, such as interactive television.

The present invention overcomes each of these disadvantages by providing a web based interactive multimedia story authoring system and method. The web based system and method of this invention provides virtually unlimited content allowing a user to choose components making up a particular story. Stories are created by the user accessing a host web site having user executable commands to enable user to create a story. Accordingly, the user does not have to pre-install any software on the user's computer, or otherwise confront software or hardware compatibility issues in creating a story. Stories created through the host web site can be shared with a global audience through basic e-mail communications. Writing competitions are easily conducted through the web site which allows multiple users to trade and enter stories in a particular contest with judging of the stories being handled by a designated system administrator or judge, also having special access to the web site. Access to the web site can be achieved by any number of devices available commercially to include personal computers, PDAs, e-books, interactive TV, cable TV, satellite TV, among other available devices.

### SUMMARY OF THE INVENTION

The present invention provides a web based interactive multimedia story authoring system and method. The invention can be thought of as physically residing in three major parts, namely, a user/author part, a computer server part, and a means of communication part allowing the user/author part to interact with the computer server part. The user/author part may reside on any device that has capability for connection to the worldwide web. Examples of these devices, as discussed above, include personal computers, PDAs, e-books, interactive television, cable television, satellite television, and various wireless communication devices. For each of these devices used, the user/author part requires that worldwide web browser software be used enabling the user to access the host web site of the computer server part. Once logged on to the host web site, users can create their own stories from their own content, or content stored on the computer server. Users may further save, edit, or share their stories in accordance with functionality provided on the host web site in the form of executable user commands presented on user interface screens.

The computer server part accessible through the worldwide web contains one or more web servers and one or more database servers. The web server is host to the web site and communicates with the database server enabling users to become registered with the web site. The web server manages information to help users create, edit and share their stories. Computer software installed at the computer server part provides multimedia content management which allows users to search through a variety of story components, each of the components having a potentially limitless variety of content allowing users to build their stories, piece by piece. For users who wish to use their own content, the computer server part enables a user to upload his/her content onto databases of the database servers. The computer server part is also responsible for making available information concerning special events such as writing competitions, or other promotional events sponsored through the host web site. The database servers have a number of databases which support a variety of file formats to include audio, video, animation, and graphic art for background and/or characters/objects. A user can choose to create a story which includes some, or all of these formats. Examples of the file formats include, but are not limited to, TIFF, JPG, BMP, GIF, Windows Media™, Real Audio™, AVI, Quick Time™, and Mid Music™.

As mentioned above, users can create their own content, and then upload the content to the database servers. For example, a user could use an off-the-shelf product like Photo Shops which allows an author to draw or create digital images which can be stored in the user's computer. The created images can be saved to a standard file format and then uploaded to the database servers. Other examples of ways in which a user could create his/her own content for a story would be to scan a particular document, save it in his/her computer, and then upload the saved file to the database server. Yet another example of user created content would include images downloaded to files in the user's computer from a digital camera. These files then could also be uploaded to the database servers.

In another very broad sense, the system of this invention can be described as a data processing system including a computer processor means for processing data. The computer processor means would include the computer server part. As a data processing system, the invention further includes storage means for storing data on a storage medium. This storage means would correspond to capability at the computer server part to store data on its server databases. The invention also includes computer server means enabling access to data stored on databases at the server databases. The computer server means facilitates access to the data through the worldwide web, and also handles the electronic communications between the computer server part and the user part. Computer software means are also provided for creating a plurality of user interface screens accessible by the user on the host web site. The screens include user executable commands enabling the user to access data stored on the storage means, and further enabling the user to use selected data corresponding to components of a story. Finally, as a data processing system, the invention includes the end user part which itself includes a user device to communicate with the computer server means through the worldwide web. Some form of web browser software is installed on the user device enabling a user to make a connection with the host web site.

### BRIEF DESCRIPTION OF THE DRAWINGS

FIG. 1 is a schematic diagram illustrating the major parts of the web based interactive story authoring system of the invention, to include illustrating the flow of information within the system;

FIG. 2 is a flow diagram illustrating one conceptual view of the steps involved with creating the stories through a user's access to the web site;

FIG. 3 is an example of a user interface screen which a user may review once the user has accessed the host web site, and further illustrates various pull-down menus corresponding to a tool bar common to many web browsers;

FIG. 4 illustrates a user interface screen or display demonstrating various functions and options which a user may choose to edit or create a story;

FIG. 5 is another user interface screen illustrating how to begin creating a new story;

FIG. 6 is a simplified flowchart illustrating some of the steps in how to initially create a story, in accordance with options made available on the user interface screen of FIG. 5;

FIG. 7 is another user interface screen illustrating how to enter text for a particular story;

FIG. 8 is a simplified flow diagram illustrating how to enter text in accordance with the screen of FIG. 7;

FIG. 9 is another user interface screen illustrating how to select a background for a particular story;

FIG. 10 is a simplified flow diagram illustrating how to select background in accordance with the screen provided in FIG. 9;

FIG. 11 is another user interface screen illustrating how to select characters or objects for a particular story;

FIG. 12 is a simplified flow diagram illustrating how to select characters/objects in accordance with the screen of FIG. 11;

FIG. 13 is another example of a user interface screen illustrating how to move chosen characters or objects to a desired position or location on the background;

FIG. 14 is a simplified flow diagram illustrating how to move the chosen characters/objects in accordance with the screen of FIG. 13;

FIG. 15 is another example of user interface screen illustrating how to select music or audio to be incorporated within a particular story;

FIG. 16 is a simplified flow diagram illustrating how to select music or audio in accordance with the screen of FIG. 15;

FIG. 17 is a simplified block diagram illustrating how to add additional pages to a particular story;

FIG. 18 is another example of a user interface screen illustrating how to save a particular story on the host web site, create a user account, and complete other administrative functions;

FIG. 19 is a simplified flow diagram illustrating how to manipulate the functionality illustrated in the screen of FIG. 18;

FIG. 20 is another user interface screen which may be viewed by a system administrator charged with reviewing the stories that are desired to be published by authors submitting the same for approval or disapproval;

FIG. 21 is another user interface screen illustrating means by which the system administrator may approve, disapprove, or rate a particular story;

FIG. 22 is a simplified flow diagram illustrating how a system administrator reviews, and rates stories submitted by users; and

FIG. 23 is another user interface screen illustrating how to create an account on the host web site.

### DETAILED DESCRIPTION

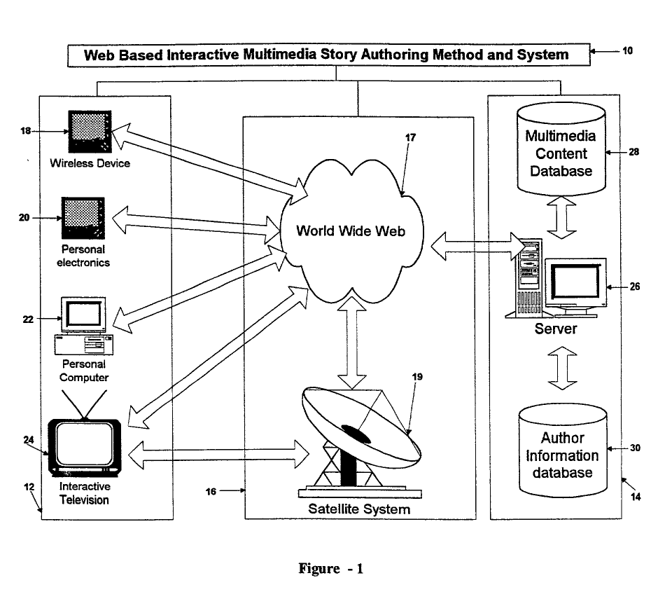

The web based interactive multimedia story authoring system and method of this invention is depicted as part of the schematic diagram of FIG. 1. The system and method can be conceptually broken down into three major parts, namely, the user/author part 12, the computer server part 14, and the means of communication part 16 allowing the user/author part 12 to communicate with the computer server part 14. This means of communication 16 is illustrated as including the worldwide web 17 and a satellite system 19. A number of examples of devices are shown for the user/author part 12. These include wireless devices 18, personal electronic devices 20 (such as PDAs or the like), personal computers 22, and interactive television 24. Each of these devices have the capability to connect with the worldwide web. For each of the devices, web browser software is installed on the device, along with a modem or other communication link which facilitates actual transfer of data electronically to and from the worldwide web 17. In the event that an interactive television set is used in a satellite television platform, the satellite system 19 is also an integral component in establishing communications with the worldwide web. As shown, interactive television 24 can directly communicate with the worldwide web 17, or satellite interactive television may also require an intermediate communication step with satellite system 19.

The computer server part 14 is illustrated as including three major elements, namely, the computer server 26, a multimedia content database 28, and an author information database 30. The computer server 26 although shown as a single computer, can be in the form of a number of networked computers which have one or more server databases. The multimedia content database 28 represents those data fields or records which are stored on the computer server 26, and include any number of file formats which may be accessed by a user for use as components of a story. As mentioned above, the multimedia content database 28 may include file formats for audio, video, animation, and background images, and/or character/object images. The author information database 30 represents data which is initially created or retrieved by a user, and then uploaded to one or more databases at the computer server 26. Thus, the author information database 30 is actually a database which continues to be altered over time based upon user information uploaded to the computer server. The multimedia content database 28 also is altered over time as authors can upload new data to this database, and a system administrator can choose to modify or update data in this database as well.

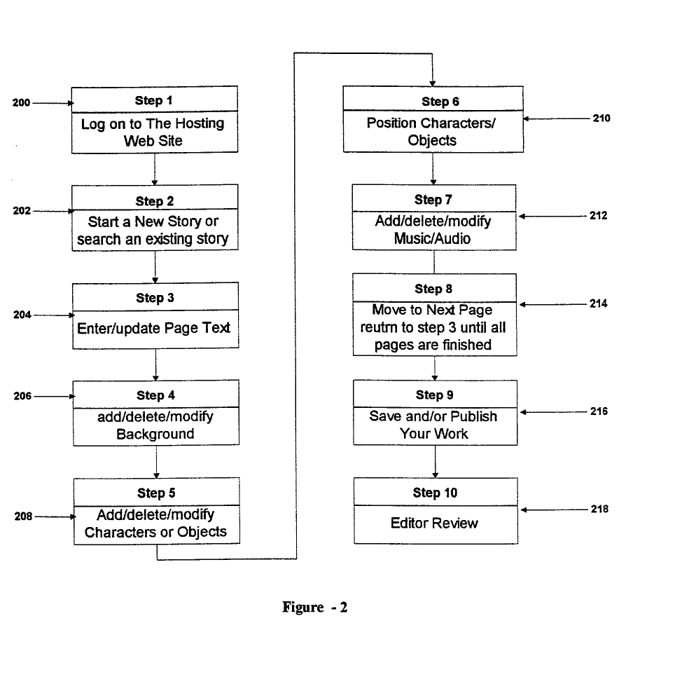

FIG. 2 is a simplified flow diagram illustrating in one conceptual sense the major steps in creating a story in accordance with the present invention. It shall be understood that this simplified flow diagram does not represent critical steps, or represent each and every step in the method of this invention. Rather, this figure is provided to simply summarize how a story is created, and to establish a baseline for understanding a more detailed discussion of each step. Block 200 shows step 1 which is for a user to log onto the hosting web site, hosted by the computer server 26. At block 202, (step 2) through a user interface screen, the user is provided the option to create a new story or search an existing story for review, edit, or other purposes. As shown at block 204 (step 3), the user then enters or updates text for a particular page of the story created or being edited. At block 206 (step 4), the user may add background images to a new story, or delete, add, or otherwise modify background images for an existing story. At block 208 (step 5), functionality is provided to add, delete, or modify characters or objects in an existing story or a new story. Block 210 (step 6) shows another step which is to physically position the characters/objects on the desired page at the desired location on the page. Block 212 (step 7) shows the step of adding, deleting, or modifying any music or audio which is created for a new story, or an existing story. Block 214 (step 8) discloses the step of moving to the next page of the story, and returning to step 3 to modify components of the story as desired. Block 216 (step 9) discloses the step of saving and/or publishing the story. Block 218 (step 10) discloses the step of editor review wherein a system administrator reviews stories prior to the stories being published. This editor review step involves reviewing story content for offensive material and/or rating a particular story if the story has been entered into a contest.

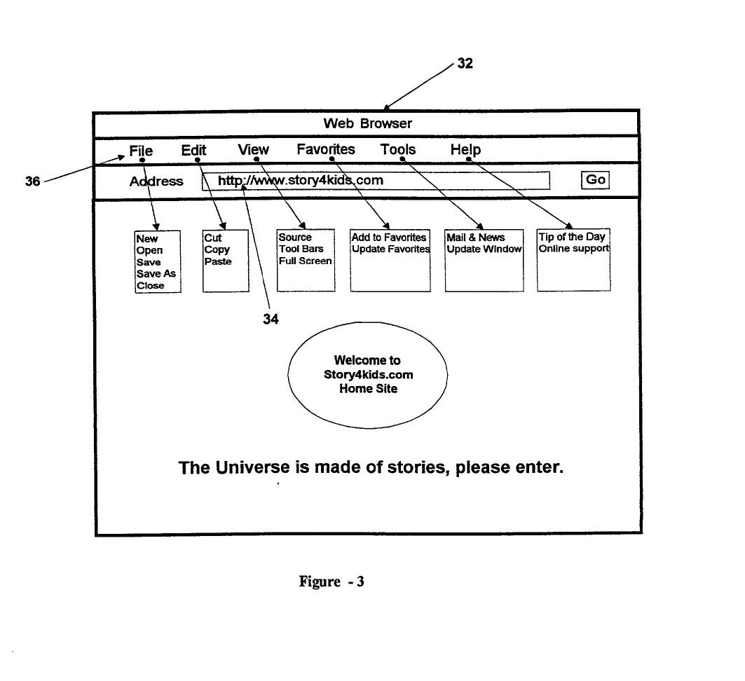

FIG. 3 represents a common user interface screen 32 of a web browser wherein a user has logged on to the web site hosted by the computer server. As well understood by those skilled in the art, the web browser allows the user to perform web browser functions, along with providing access by the user to the particular web site addressed. An example web site address 34 along with a menu bar 36 are illustrated. The menu bar for each of the various options are also shown, and are standard for many web browsers such as Internet Explorer® and Netscape Navigator®, to name a few. FIG. 3 also shows the home page of the web site, the particular functionality of the web site to be discussed in further detail below.

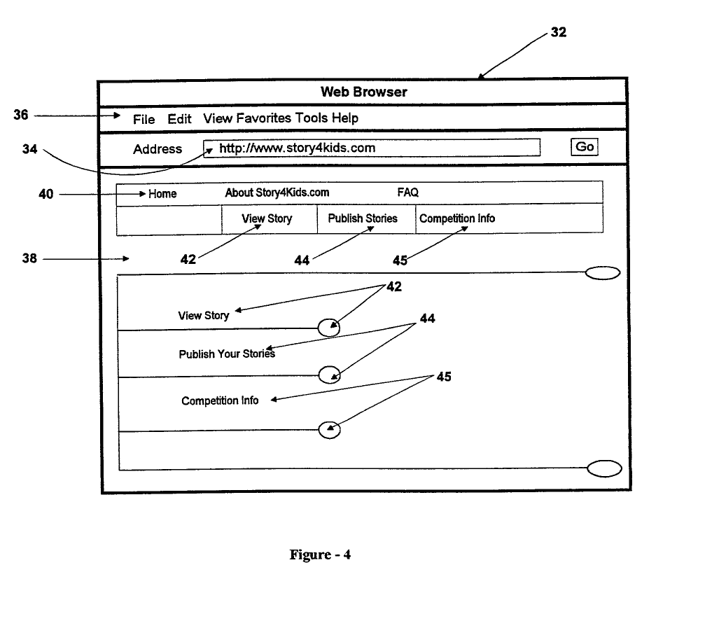

FIG. 4 illustrates the user interface portion 38 of the web site enabling a user to conduct certain functions in accordance with the web site tool bar 40. Two exemplary functions which can be triggered by a user include viewing existed stories, or creating new stories. These functions can be activated by the user by clicking on buttons 42 and 44, as desired by the user. The ability of a user to click on various functions of the web site can be defined as user executable commands.

Various other buttons are provided in which the author may to choose to execute other functions to include log in options 52, updating an existing story 56, creating a user account 58, and updating an existing account 60. These are each discussed further below.

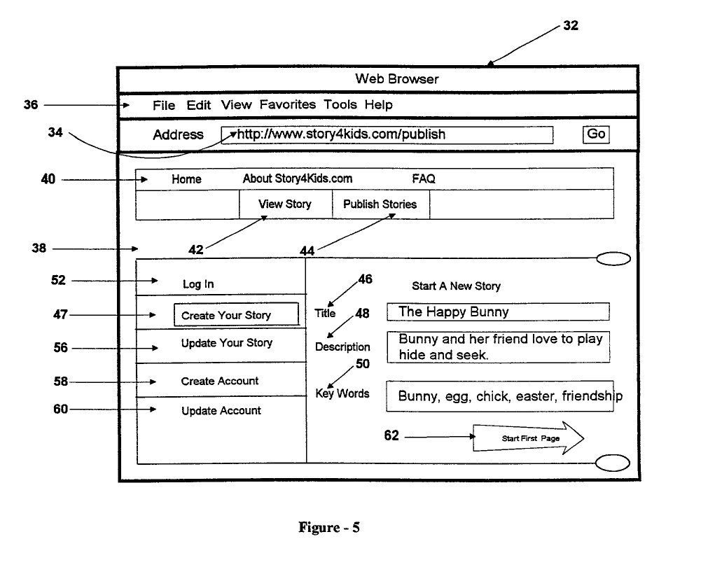

FIG. 5 illustrates a first step in creating a new story. First, the user would click on the publish your stories button 44 which in turn would provide the portion of the user interface screen shown on the left side of FIG. 5 allowing the user to select various options. At that point, the user could click on button 47 (create your stories), which, in turn, would show information on the right side of FIG. 5. The author could then enter the title 46 of a new story, a brief description 48 of the story, and key words 50 which the author may choose to allow a search function to find the particular story based upon the key words. The user would enter this text in the conventional way, i.e., by moving a cursor to the particular data field and typing in the desired text through a keyboard or other data entry device. Then the user can begin creation of the story by clicking on the “start first page” button/icon 62.

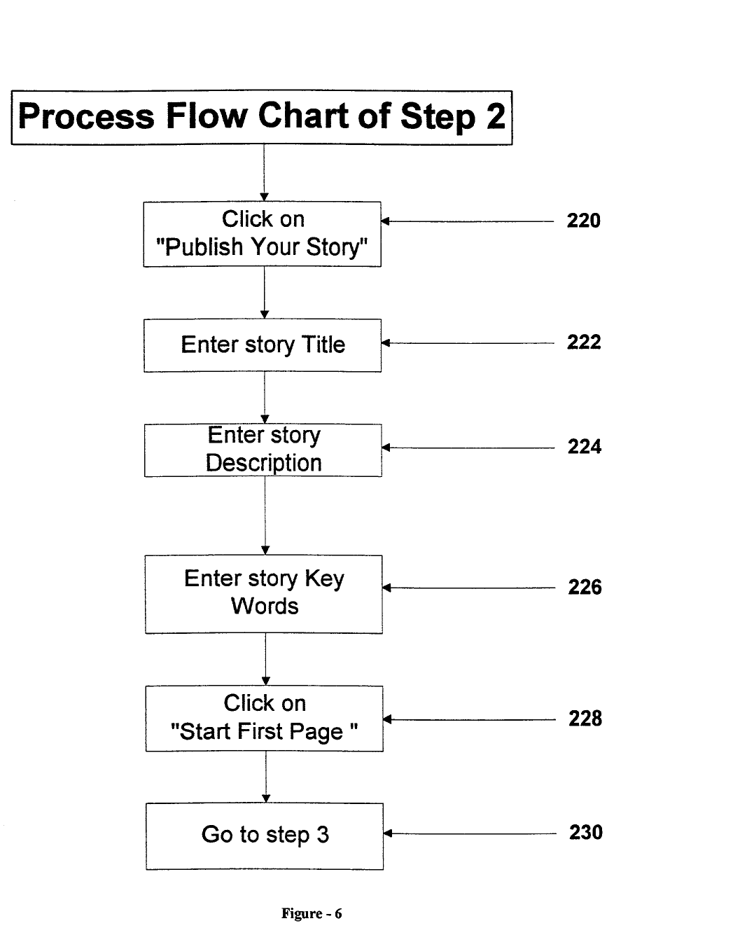

FIG. 6 (step 2) briefly summarizes the actions which the user takes at FIG. 5, namely, clicking on “publish your story” at block 220, entering a story title at block 222, entering a brief story description at block 224, entering story key words at block 226, then clicking on “start first page” at block 228. The user then proceeds with step 3 shown at block 230.

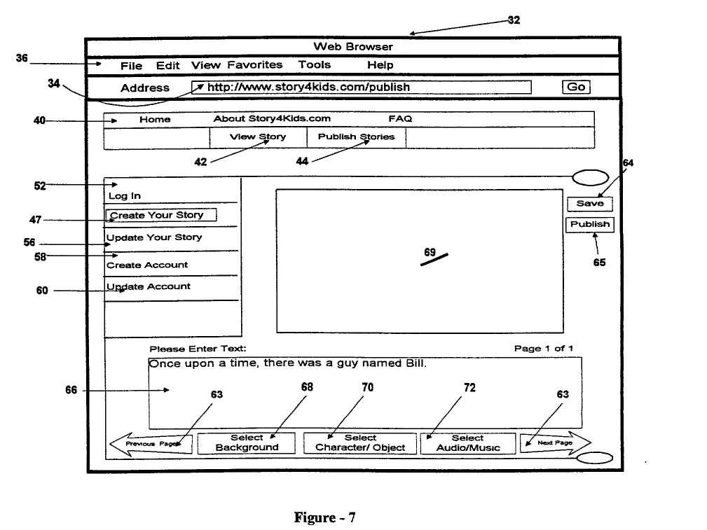

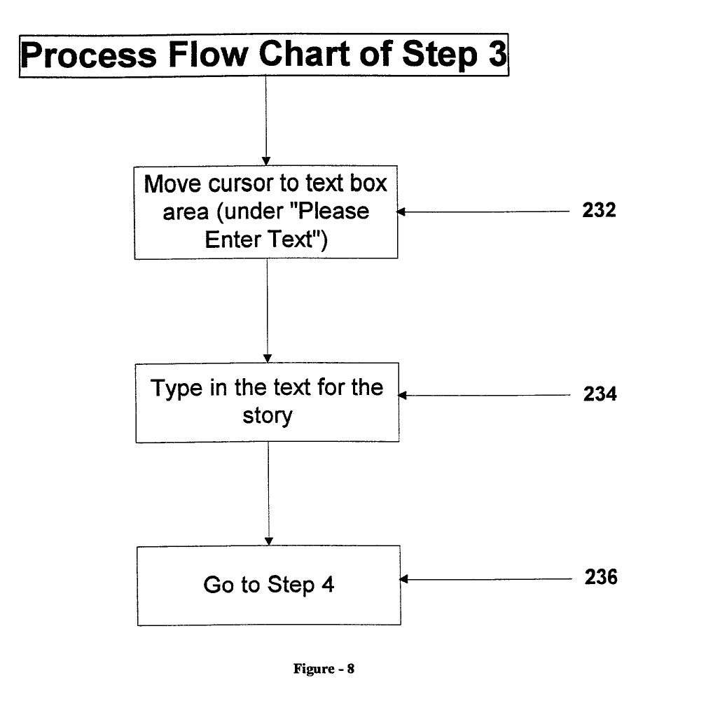

FIG. 7 illustrates a user interface screen showing how a user may enter text for a particular page of the story being created. A user moves the cursor to the text box area 66 and types in the text corresponding to an illustration, music, or other component which appears in the visual image box 69 on this particular page. This user interface screen also illustrates near the bottom of the screen the buttons which enable a user to select components to be placed in the visual image box 69. These include select background button 68, select character/object button 70, and select audio/music button 72. FIG. 8 (step 3) briefly summarizes the above description of FIG. 7. FIG. 8 shows moving cursor to the text box area 66 at block 232, typing in the desired text for the story on that particular page at block 234, and then moving to the next step (step 4) at block 236.

FIG. 7 also includes the save button 64 and the publish button 65. In the event a user wishes to terminate his/her log-on, the save button 64 can be executed prior to logging off which allows user to save the story created or edited up to that point. In the event the user has finished authoring the particular story and the user wishes to publish the work for others to view, the user would click on the publish button 65 which would take the user to another user interface screen (not shown) confirming that the author wished to publish the story as found in its current state. FIG. 7 further indicates navigation buttons 63 which allow a user to navigate between pages as desired.

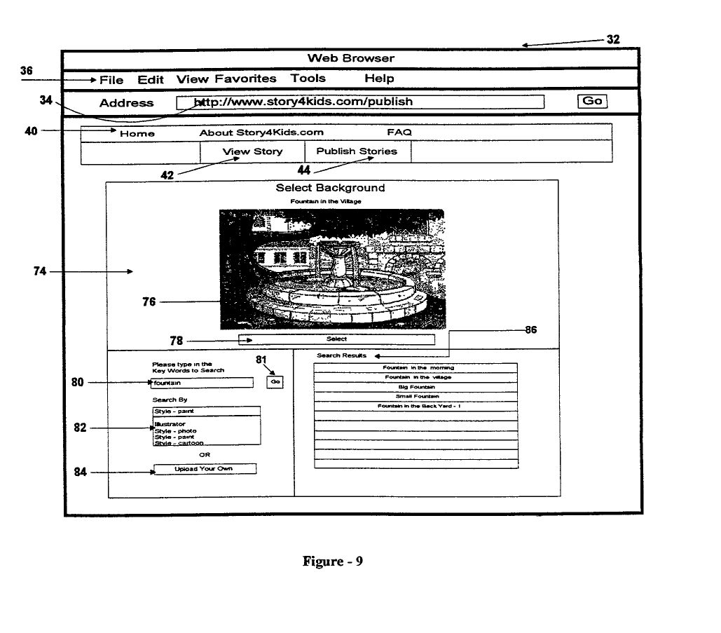

FIG. 9 illustrates a user interface screen 74 corresponding to a screen which allows the user to select the background for a particular page. The image of a particular selected background is shown as background image 76. If the user wished to select this particular image, the user would simply click on the select button 78 which would place the image 76 in the visual image box 69. Prior to selecting a particular image 76, the user would have the option to select images which are stored on the various databases in the database servers. This selection can be conducted via searches performed by the user. A particular image could be searched: (1) by key words which the user enters in field 80, (2) by selecting a particular style from pull down menu 82, or (3) by the user uploading his/her own image by clicking on button 84. Clicking on button 84 would take the user to another user interface screen (not shown) providing specific instructions to the user on uploading various file formats to use as an image 76. As discussed previously, the user could upload any number of file formats.

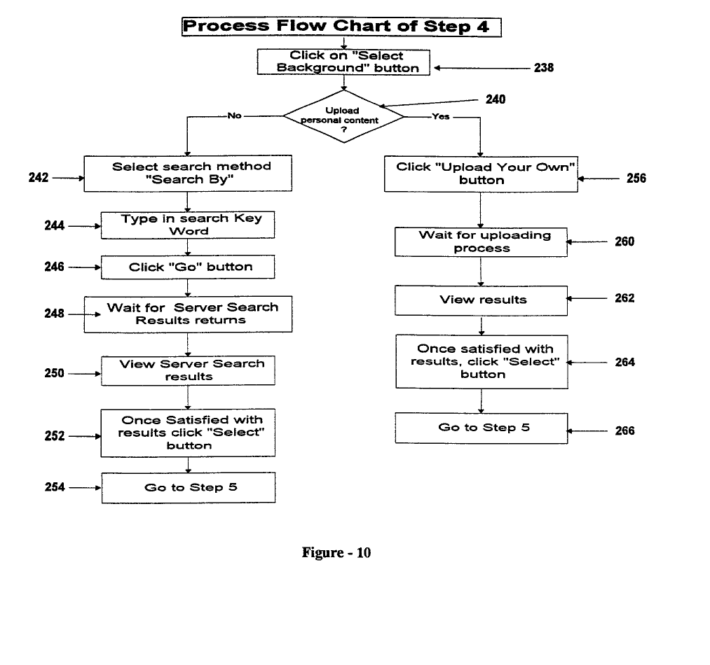

If a user decided to execute a search based upon data available in the multimedia content database 28, the search results would be listed at field 86. The block diagram of FIG. 10 (step 4) summarizes the steps involved in selecting a particular image 76. As shown at FIG. 10, the user would click on the “select background” button of FIG. 7 at block 238. At block 240, the user decides whether to upload personal content or choose content on content database 28. At block 242, the user selects the search method. At block 244, the author may type in a key word. At block 246, the user would click on the go button 81 to execute the search. At block 248, the user waits for server search results. At block 250, the user would view the server search results. At block 252, once satisfied with the results, the user would click on the select button 78 to import the image 76 to box 69. At block 254, the user then could proceed with the next step (step 5). If the user decided to upload personal content, then, as shown at block 256, the user would click on the “upload your own” button 84. At block 260, the user waits for the uploading process. At block 262, the user views the results of the upload. At block 264, once satisfied with the results, the user would click on the “select” button 78 to import the image 76 to box 69. At block 266, the user proceeds with the next step (step 5).

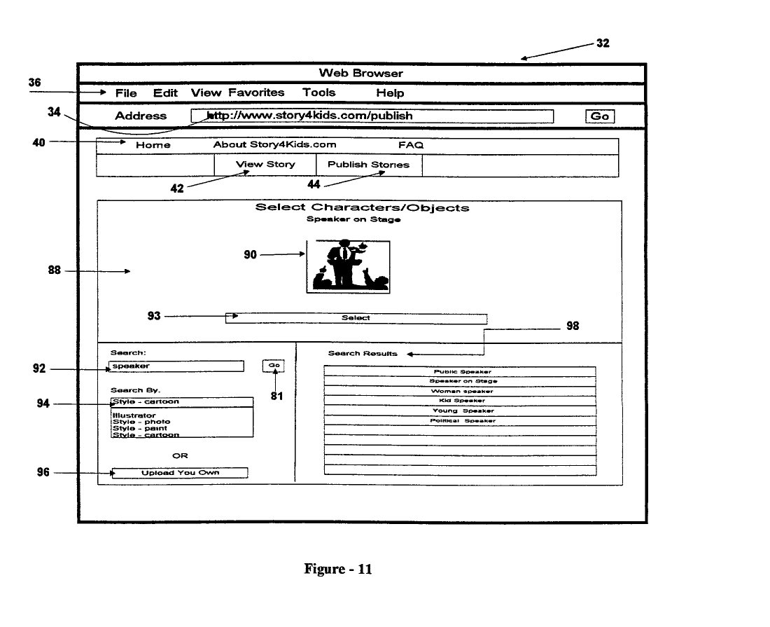

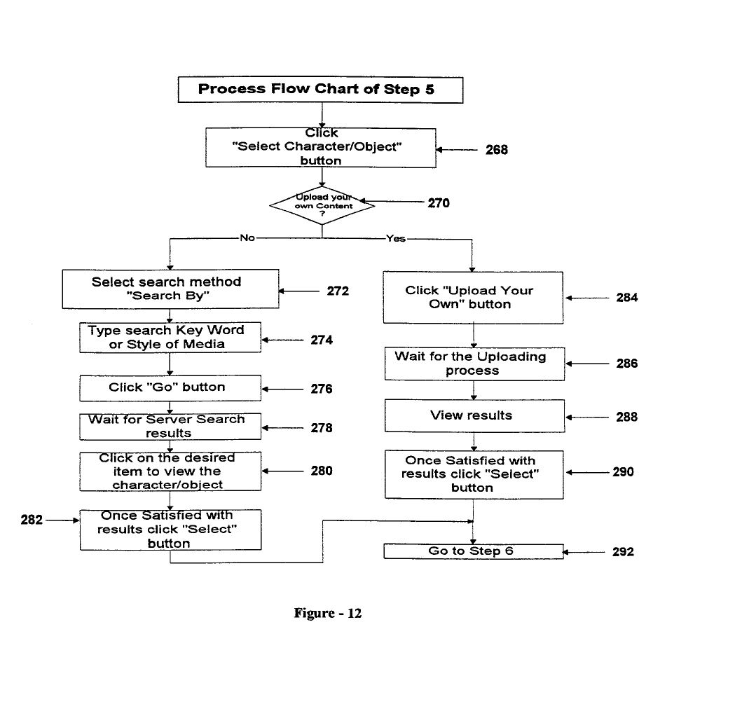

FIG. 11 illustrates another user interface screen 88 which allows a user to select a particular character or object to be placed on the previously selected background. The character or object could be in the form of any desired visual image 90. Now also referring to FIG. 12 (step 5), the basic steps which a user uses in order to select a character or object. At block 268, the user selects the “select character/object” button 70. At block 270, the user decides whether to upload his/her own character/object content. If the user decides to use the character/object data available on the server database, the user selects the search method at block 272. At block 274, the user would have the option to type in a key word within field 92. The operator would also have the option to search by a particular style of media available by selecting the desired option at pull down menu 94. The user would then click the go button 81 at block 276, and then wait for the search results at block 278. At block 280, the user would then click on the desired character/object as presented within the search results appearing in field 98. Clicking on the desired character/object 90 would result in the display of the particular character/object chosen. At block 282, once satisfied, the user would click on the select button 93 which would import the particular character/object 90 and place it on the previously selected background in box 69.

Although selecting a background is presented as a step prior to selecting character/objects, it shall be understood that there is no required or specified order in which a user may decide to create a story. That is, a user may choose to complete the entire text of a story, then go back and add background and character/objects as desired. Furthermore, the user has the option of skipping between pages to add, delete, or modify any particular page at any sequence as selected by the user. Each time a user has completed selection of a particular background or character/object, or has deleted or modified background or a character/object, the user is provided the various select options as shown at the bottom of the user interface screen of FIG. 7. This insures that the user may easily navigate within his/her own story to modify any component of the story as desired.

Returning to FIG. 12, if the user decided to upload his/her own content at block 270, then at block 284, the user would click the “upload your own button” 96. At block 286, the user would have completed selection of the content to be uploaded, and then would wait for the uploading process. At block 288, the user would view the results of the user's upload by viewing the image which would appear in the box 90. Once satisfied with the result, the user would click on the select button 92 which would import the selected image to the box 69. At block 292, the user is then prepared to move to the next step (step 6).

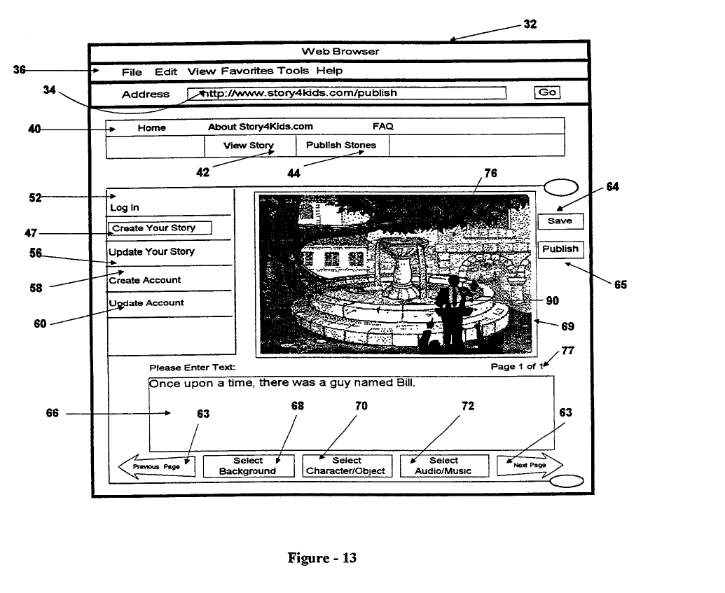

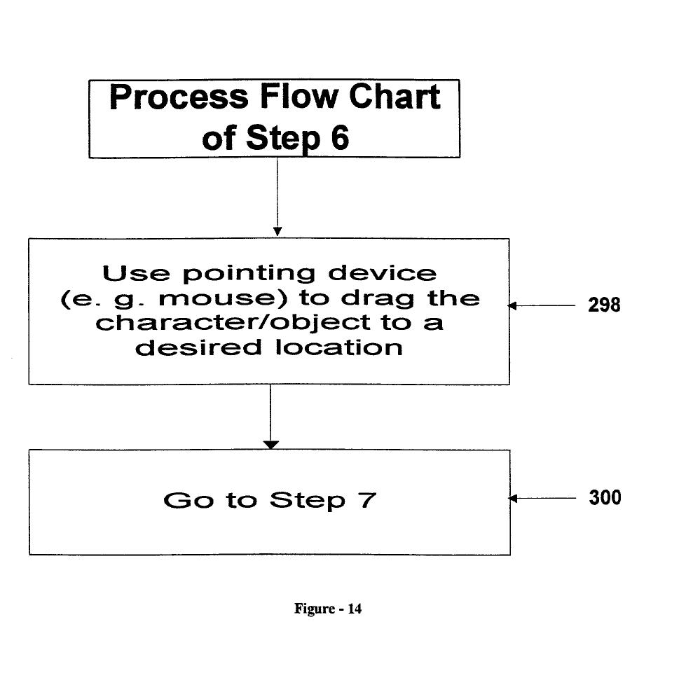

FIG. 13 illustrates another user interface screen which shows the image of the chosen character/object 90 superimposed over the image of the background 76 within box 69. At this point, the user is able to position the character/object 90 on the background 76. This is achieved by simply using a pointing device (such as the computer mouse) and dragging the character/object 90 to the chosen location on the background 76. This step is also shown at FIG. 14 (step 6) at block 298. At block 300, the user is then ready to proceed with the next step (step 7).

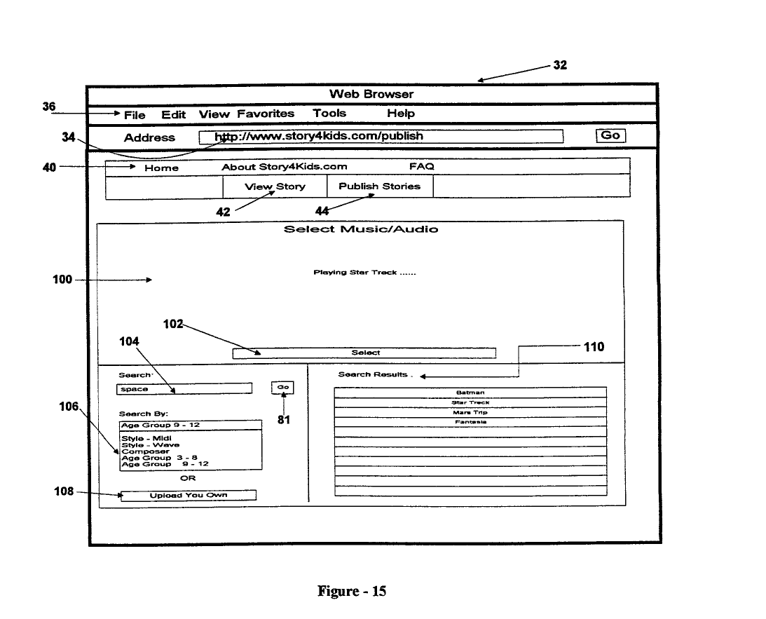

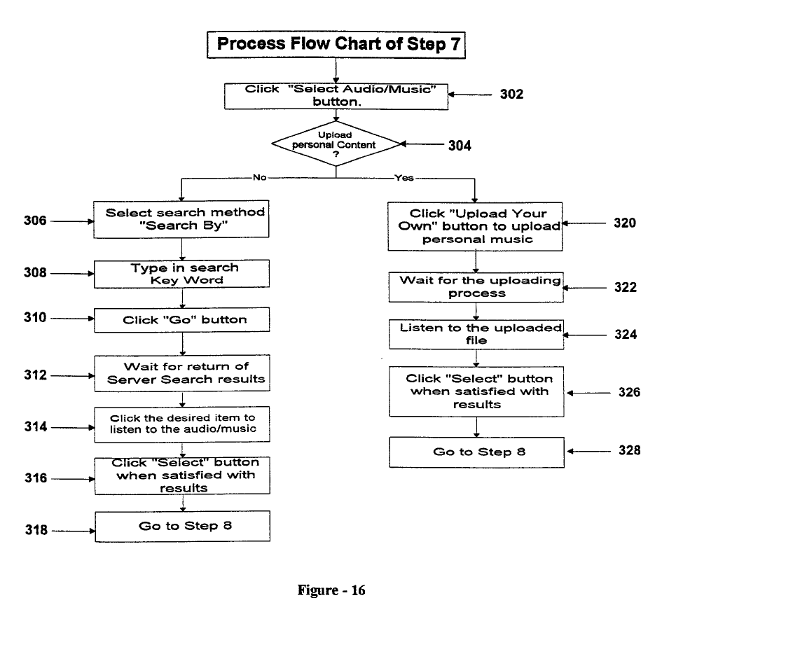

FIG. 15 illustrates yet another user interface screen 100 which the user may select to incorporate music or audio in the story. This particular screen would be accessed by the user clicking on the select audio/music button 72. Now also referring to FIG. 16 (step 7), the user would select the audio/music button 72 (block 302). At block 304, the user would decide whether to upload personal content. At block 306, the author would select the search method. At block 308, the author could choose to type in a key word at field 104 for a key word search. Alternatively, the author could choose to search by age group, or any other criteria as provided in the pull down menu 106. At block 310, the author would click on the go button 81 to execute the desired search. At block 312, the user would wait for return of the search results. At block 314, the user could view and click on the desired item appearing in the search results field 110. The user would then listen to the music/audio chosen. At block 316, the user would then click the select button 102 to import the particular chosen audio/music component to the particular page. In the case of music/audio, the music/audio would be played only when a viewer was viewing the particular page. At block 318, the user could then proceed with the next step (step 8) in creating a story. At block 320, if the user decided to upload his/her own content, the user would click on the upload your own button 108. At block 322, the user would wait for the uploading process. At block 324, the user would listen to the uploaded file 320. The name of the uploaded file would appear in field 110 once uploaded. At block 326, the user would click on the select button 102 when satisfied with the selection of the particular uploaded file. At block 328, the user is then ready to proceed with the next step (step 8) in the process.

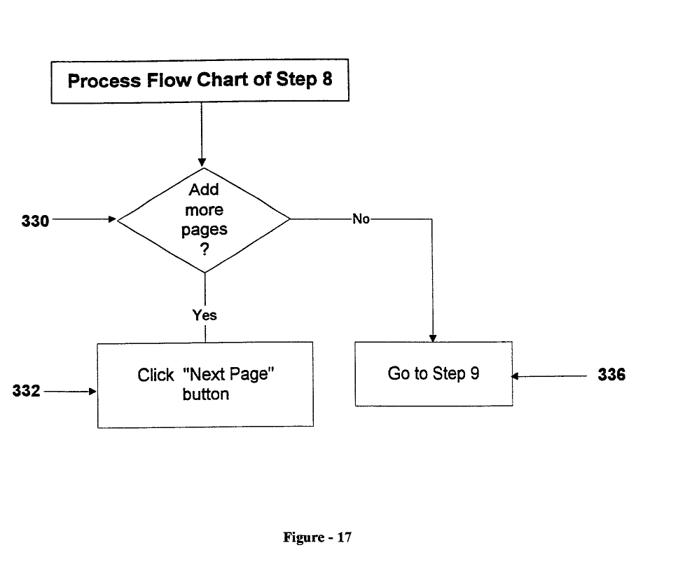

FIG. 17 (step 8) simply illustrates the repetitive process by which a user may create additional pages once all of the components are completed for a particular page. As shown at block 330, a decision is made whether to add more pages to the story. If more pages are desired to be created within the story, then as shown in block 332, the user would simply click the next page button 63 and repeat selected steps to create various components for each page. If no more pages were desired to be created, the user would proceed to the next step (step 9), shown at block 336.

Not previously mentioned above is the manner which the user may wish to delete a character/object, background, or other component of a story. In such case, the user would simply move the cursor or pointing device to the component appearing. on the screen to be deleted, and then press the delete key on the users key board.

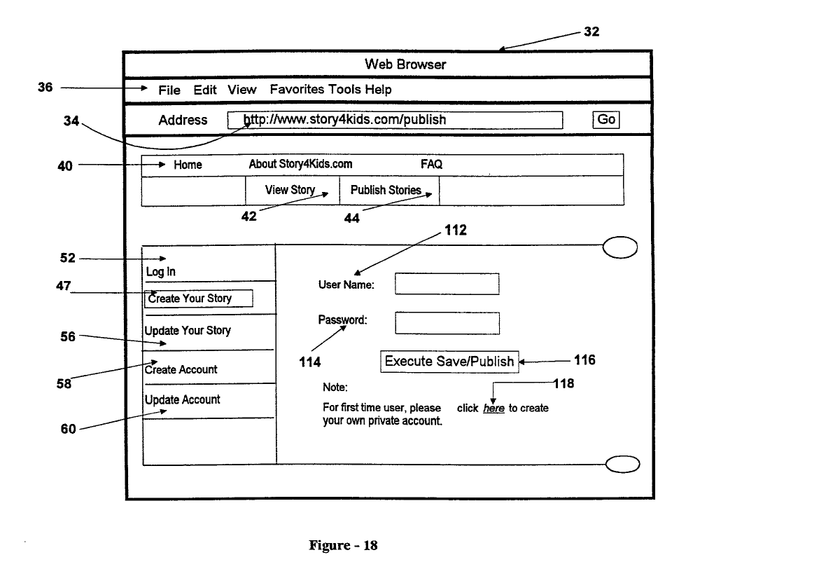

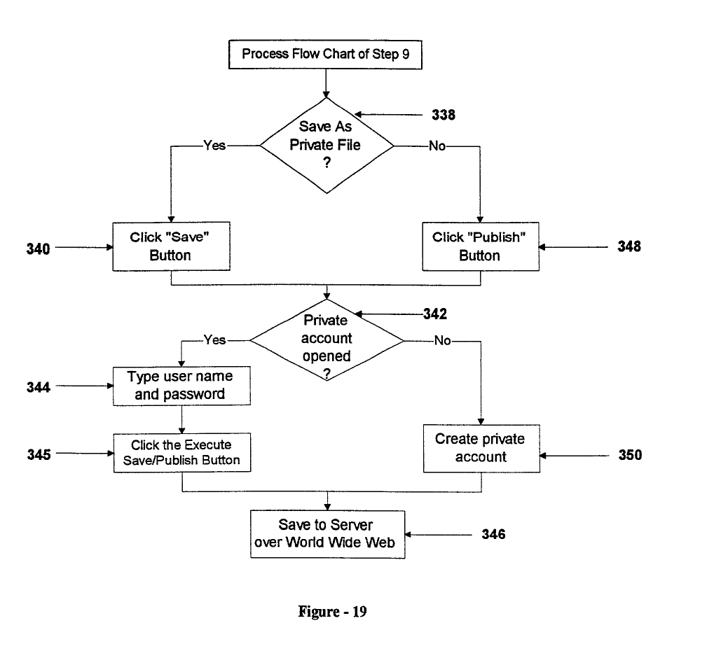

Once the user has finished the creation or editing of a story, the user can execute the save button 64 to save the story as a private draft, or can execute the publish button 65 to submit the story for publication, which will also automatically save the story (see FIG. 13). Now referring to FIG. 18 and FIG. 19 (step 9), at block 338, the user decides whether to save as a private file. At step 340, the user clicks on the save button 64 to save the particular draft as a private file. At block 342, if a private account is already open then at block 344, the user types in his/her user name and password, in fields 112 and 114 shown at FIG. 18. As shown at block 345, the user will then click on the execute save/publish button 116. At block 346, the user's private draft would be saved to the server. If the user wishes to publish the story, as shown at block 348, the user would click on the publish button 65. If a user account was established, the user would type in the user name and password, and then click on the execute save/publish button 116.

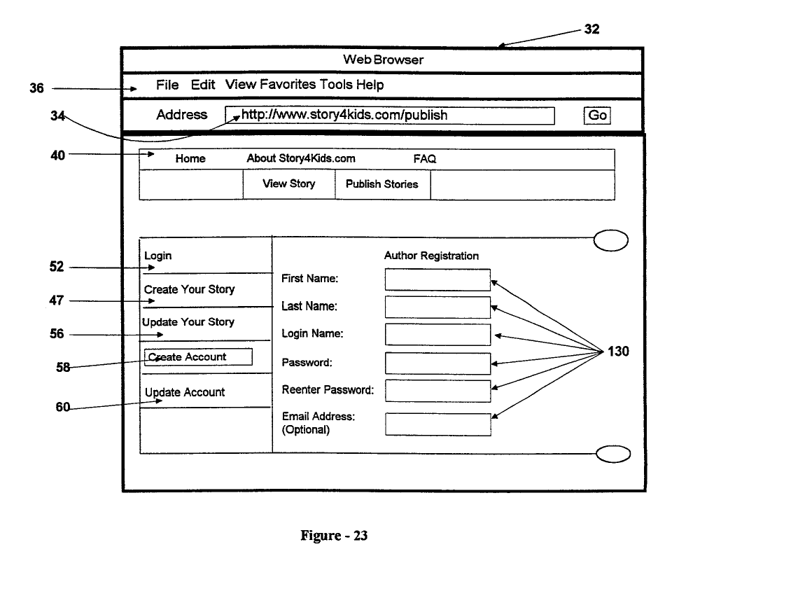

To create a private account as shown at block 350, the user would click on the notice 118 of FIG. 18 and the user would be instructed how to create a new private account on a separate screen (see FIG. 23).

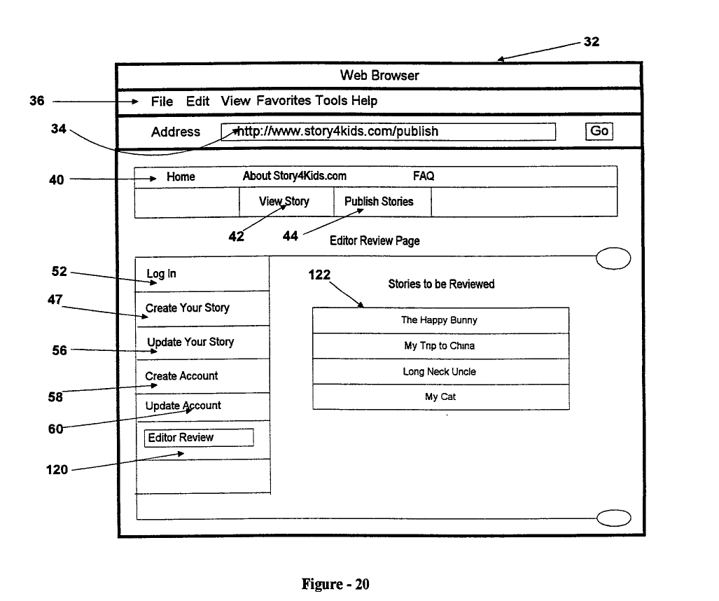

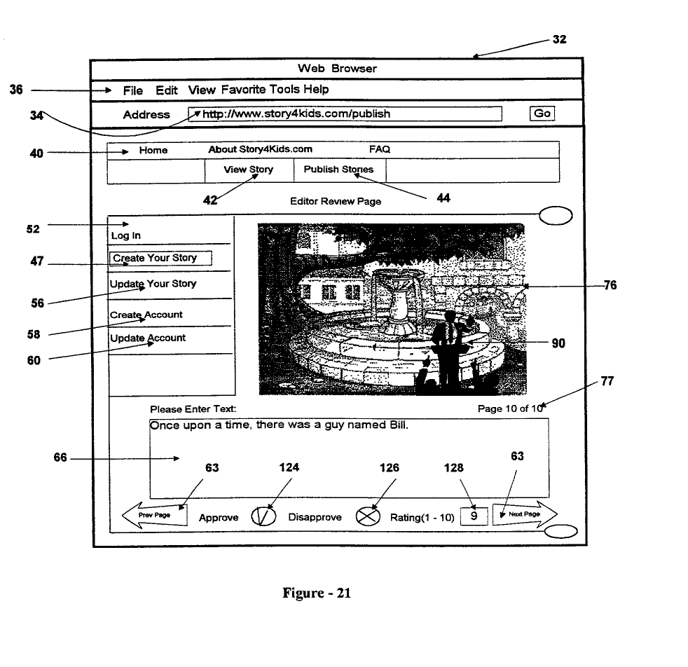

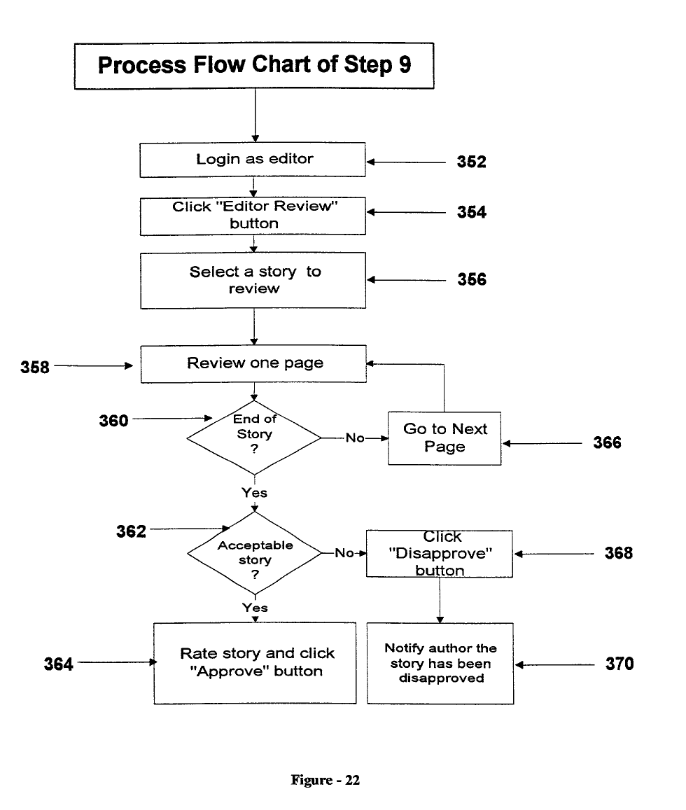

FIG. 20 illustrates another user interface screen which is viewable only by a system administrator who would be charged with reviewing stories to be published. The system administrator would click on the editor review button 120 which in turn would provide a listing of stories which have been requested for publication by various authors. These stories to be reviewed would appear in field 122. The system administrator would then systematically click on each of the stories appearing in field 122 enabling the system administrator to view each of the stories. The system administrator could be given authorization to also edit or otherwise modify a story submitted for publication, just as the particular user would have access to do so. FIG. 21 illustrates another user interface screen viewable only by the system administrator enabling the system administrator to approve, disapprove, and rate the particular story submitted for publication. As shown, this functionality is provided on the last page of the particular story. In this figure, there are ten pages for this story as indicated at field 77. The system administrator would then click on the approve 124 or disapprove 126 buttons. The system administrator could also provide a rating of the story based upon preset criteria by entering the appropriate rating in the field 128. FIG. 22 (step 10) summarizes the previously discussed steps which can be executed by a system administrator acting as an editor. At block 352, the system administrator logs in as an editor. At block 354, the administrator would click on the editor review button 120. At block 356, the editor would choose a particular story to review. As shown in blocks 360-370, the system administrator would conduct the review to include approval/disapproval of a particular story, and rating of the particular story. The system administrator could then generate an e-mail to the author of story, telling the author the result of the review and/or rating.

FIG. 23 (new) illustrates a user interface screen allowing a user to create an account. The user completes the fields 130 to create an account enabling the user to save and publish stories over the web site.

Also, in accordance with the invention, the invention facilitates a method of conducting a web based story competition for stories created on the multimedia authoring system. Referring back to FIG. 4, a user could click on the competition info button 45 which would lead the user to another screen (not shown) explaining the rules of the competition, and the method by which the user enters the competition. For example, the user could be instructed to type in a particular key word in the key words field 50 (FIG. 5). Once a story was selected for publication by the user, any story title having the competition key word entered in field 50 would result in the story being submitted to the system administrator for review in the particular competition. Once the system administrator rated each of the entrant stories, the results of the contest could be announced by posting the results on another user interface screen (not shown) accessible by the entrants. Alternatively, the results could be individually posted to the user accounts in a log-in screen (not shown).

This invention has been described in detail with reference to a particular embodiment thereof, but it will be understood that various other modifications can be effected with the spirit and scope of this invention.

What is claimed is:

1. A method of creating a story in a multimedia story authoring system, said method comprising the steps of:
providing a database of information including data to be used as components in making up a multimedia story within the authoring system;
providing a host computer server for storing and manipulating said database;
making said database available for access by users through a hosting website;
providing a plurality of user interface screens, said screens including user executable commands enabling a user logged onto said hosting website to access said database, and use selected data therein corresponding to components of a story, said components of said story comprising a story text field for entering story text composed by the user, and characters/objects; and
creating a story by executing the commands on said user interface screens to select data corresponding to the components of the story, and entering desired story text.

2. A method, as claimed in claim 1, wherein:
said components further include background.

3. A method, as claimed in claim 1, wherein:
said components further include music.

4. A method, as claimed in claim 1, wherein:
said components further include audio.

5. A method, as claimed in claim 1, wherein said making step further includes the step of:
conducting communication between a user and the host computer server through the worldwide web.

6. A method, as claimed in claim 1, wherein said making step further includes the step of:
conducting communication between the user and the host computer server through satellite.

7. A method, as claimed in claim 1, wherein said making step further includes the step of:
conducting communication between the user and the host computer server through the worldwide web and through satellite.

8. A method, as claimed in claim 1, wherein said database includes multimedia content controlled and manipulated-by a system administrator of the host computer server, and said database further includes user data selected by the user and uploaded by the user to the host computer server and stored in said database.

9. A method, as claimed in claim 1, wherein:
the website is accessed by using a wireless device.

10. A method, as claimed in claim 1, wherein:
the website is accessed by using a personal electronic device.

11. A method, as claimed in claim 1, wherein:
the website is accessed by using a personal computer.

12. A method, as claimed in claim 1, wherein:
the website is accessed by using interactive television.

13. A method, as claimed in claim 1, further including:
creating a user account on the hosting website enabling the user to independently access said website to create new stories, and to edit existing stories.

14. A method, as claimed in claim 1, further including the step of:
editing an existing story by logging on te the website, and manipulating the executable commands on the user interface screens to add or delete one or more of said components in the existing story.

15. A method, as claimed in claim 1, further including the step of:
conducting an editor review of a created story to determine the existence of offensive content, and providing feedback to an author of the story in the form of an approval or disapproval of the story, said feedback being accessible to the user on a user interface screen.

16. A method, as claimed in claim 1, further including the step of:
publishing a created story by executing a command on one of said user interface screens making said story accessible to other users who log on to the website.

17. A method, as claimed in claim 1, further including the step of:
searching for stories stored in said database by executing a search request command on one of said user interface screens.

18. A method, as claimed in claim 17, wherein said searching step is conducted by user.

19. A method, as claimed in claim 17, wherein said searching step is conducted by key words.

20. A method, as claimed in claim 1, further including the step of:
conducting an editor review of a created story to rate the story based upon preset criteria.

21. A method, as claimed in claim 1, further including the step of:
sharing a created story by sending an e-mail transmission including said created story as an attached file to the e-mail transmission.

22. A method, as claimed in claim 1, further including the step of:
sharing a created story by sending an e-mail transmission including a hyperlink to said created story stored on said database.

23. A method of creating a story in a multimedia story authoring system, said method comprising the steps of:
providing a database of information including data representative of components usable in a multimedia story;
providing a host computer server for storing and manipulating said database;
providing a hosting website enabling access by users to create stories from data in said database;
accessing the website and executing commands on user interface screens to choose desired components of said database to create a story, said components comprising a story text field for entering story text composed by the user, and characters/objects; and
saving a created story as a computer file on said host computer.

24. A method, as claimed in claim 23, wherein:
said components further include background.

25. A method, as claimed in claim 23, wherein:
said components further include music.

26. A method, as claimed in claim 23, wherein:
said components further include audio.

27. A method, as claimed in claim 23, wherein said third providing step further includes the step of:
conducting communication between the user and the host computer server through the worldwide web.

28. A method, as claimed in claim 23, wherein said third providing step further includes the step of:
conducting communication between the user and the host computer server through satellite.

29. A method, as claimed in claim 23, wherein said third providing step further includes the step of:
conducting communication between an user and the host computer server through the worldwide web and through satellite.

30. A method, as claimed in claim 23, wherein said database includes multimedia content controlled and manipulated by a system administrator of the host computer server, and said database further includes user data selected by the user and uploaded by the user to the host computer server and stored in said database.

31. A method, as claimed in claim 23, wherein:
the website is accessed by using a wireless device.

32. A method, as claimed in claim 23, wherein:
the website is accessed by using a personal electronic device.

33. A method, as claimed in claim 23, wherein:
the website is accessed by using a personal computer.

34. A method, as claimed in claim 23, wherein:
the website is accessed by using interactive television.

35. A method, as claimed in claim 23, further including:
creating a user account on the hosting website enabling the user to independently access said website to create new stories, and to edit existing stories.

36. A method, as claimed in claim 23, further including the step of:
editing an existing story by logging on to the website, and manipulating the executable commands on the user interface screens to add or delete one or more of said components in the existing story.

37. A method, as claimed in claim 23, further including the step of:
conducting an editor review of a created story to determine the existence of offensive content, and providing feedback to an author of the story in the form of an approval or disapproval of the story, said feedback being accessible to the user on a user interface screen.

38. A method, as claimed in claim 23, further including the step of:
publishing a created story by executing a command on one of said user interface screens making said story accessible to other users who log on to the website.

39. A method, as claimed in claim 23, further including the step of:
searching for stories stored in said database by executing a search request command on one of said user interface screens.

40. A method, as claimed in claim 39, wherein said searching step is conducted by user.

41. A method, as claimed in claim 39, wherein said searching step is conducted by key words.

42. A method, as claimed in claim 23, further including the step of:
conducting an editor review of a created story to rate the story based upon preset criteria.

43. A method, as claimed in claim 23, further including the step of:
sharing a created story by sending an e-mail transmission including said created story as an attached file to the e-mail transmission.

44. A method of conducting a web-based story competition for stories created on a web-based multimedia authoring system, said method comprising the steps of:
providing a database of information including data representative of components usable in a multimedia story;
providing a host computer server for storing and manipulating said database;
providing a hosting website by users to create stories from data in said database;
accessing the website and executing commands on user interface screens to choose desired components of said database to create a story, said components comprising a story text field for entering story text composed by the user, and characters/objects; and
saving a created story as a computer file in said host computer;
entering data on a user interface screen indicative of a particular story and author entrant to be entered into the contest;
collecting data corresponding to the entered stories and authors;
judging the stories based upon preset criteria; and
announcing the results of the contest by posting the results on a user interface screen accessible by author entrants.

45. A method of creating a story in a multimedia story authoring system, said method comprising the steps of:
providing a database of information including data representative of the components usable in a multimedia story;
providing a host computer server for storing and manipulating said database;
providing a hosting website enabling access by users to create stories from data in said database;
accessing the website and executing commands on user interface screens to choose desired components of said database to create a story, said components comprising a story text field for entering text composed by the user, and said components comprising data selected from the group consisting of data pre-existing in said database, or data uploaded and stored by the user to said database;
searching data in the group to determine components to add to the story, said searching step enabling a user to choose data for components to add to the story; and
saving a created story as a computer file on said host computer.

46. A method, as claimed in claim 45, further comprising the step of:
editing the created story by re-accessing the website and executing commands on the user interface screens to edit the existing components of said database, said editing step further comprising the step of searching said group to determine which data to be added, deleted, or modified; and
saving the edited story on said host computer.

47. A web-based interactive multimedia story authoring system comprising:
computer processor means for processing data;
storage means for storing said data on a storage medium;
computer software means for creating a plurality of user interface screens accessible by a user, said screens including user executable commands enabling the user to access a database stored on said storage means, and enabling a user to use selected data in said database corresponding to components of a story; and
computer server means for enabling access to said database by the user through the worldwide web, said computer server also for facilitating communications between said computer server means and the user regarding creation and editing of a story.
